(19) United States
(12) Patent Application Publication
(10) Pub. No.: US 2026/0201813 A1
(43) Pub. Date: Jul. 16, 2026

(54) AIRCRAFT TURBINE ENGINE HAVING MEANS FOR DETECTING THE AXIAL DISPLACEMENT OF A FAN

(71) Applicant: SAFRAN AIRCRAFT ENGINES, Paris (FR)

(72) Inventors: Adel Cedric Abir WIDEMANN, Moissy-Cramayel (FR); Irène BUJON, Moissy-Cramayel (FR); Clément COTTET, Moissy-Cramayel (FR); Christophe Marcel Lucien PERDRIGEON, Moissy-Cramayel (FR); Alexandre Jean Joseph SALVI, Moissy-Cramayel (FR); Bastien Pierre VERDIER, Moissy-Cramayel (FR)

(73) Assignee: SAFRAN AIRCRAFT ENGINES, Paris (FR)

(21) Appl. No.: 19/127,914

(22) PCT Filed: Oct. 24, 2023
(86) PCT No.: PCT/FR2023/051670

§ 371 Date: May 7, 2025

(30) Foreign Application Priority Data
Nov. 8, 2022 (FR) FR2211613

(51) Int. Cl. F01D 21/00; G01M 15/14

(52) U.S. Cl. CPC F01D 21/003; G01M 15/14; F05D 2220/36; F05D 2260/4031

(57) ABSTRACT

The invention relates to an aircraft turbomachine comprising:
a fan (12) able to rotate about a longitudinal axis and comprising a rotor disc (30) and blades (32) with variable angular setting mounted at the periphery of the disc,
a system (50) for determining an angular setting position of a blade comprising:
   several setting reference members (52) secured to the disc,
   a position reference element (58) secured to the blade and able to change angular position in relation to the member in the event of modification of the angular setting of the blade,
   a sensor (62) fixed in relation to the fan and able to determine a relative angular position between the element and the member by detecting the passage of the element and of the member during the rotation of the fan.

The turbomachine is configured to detect an axial displacement of the fan by detecting an axial displacement of the member based on the sensor.

### TECHNICAL FIELD

This disclosure relates to an aircraft turbomachine having means for detecting the axial displacement of a fan and a method for detecting the axial displacement of a fan of an aircraft turbomachine.

### PRIOR ART

In aircraft turbomachines with or without ducted fans, it is known practice to handle the situation in which a mechanical failure occurs in the mechanical assembly connecting the fan to the rest of the engine and which leads to the detachment of the fan.

Engine manufacturers have imagined several solutions to avoid such an event:
the integration of systems for retaining the fan involving mechanical stops;
the addition of sensors which then break in the manner of mechanical fuses in the event of an axial displacement of the fan;
the installation of a double skin on mechanical elements to be able to rely on another mechanical force path to retain the fan.

### SUMMARY OF THE INVENTION

Although these systems prove satisfactory there nonetheless exists a need for the simple detection of an axial displacement of the fan.

The invention thus has the subject of an aircraft turbomachine comprising: a fan which is able to rotate about a longitudinal axis XX′ and which comprises a rotor disc and a plurality of blades with variable angular setting mounted at the periphery of the disc,
a system for determining an angular setting position of at least one blade comprising:
   several setting reference members which are secured to the rotor disc,
   a position reference element secured to said at least one blade and which is able to change angular position with respect to the setting reference members in the event of modification of the angular setting of said at least one blade,
   at least one sensor which is positioned fixedly with respect to the fan and which is able to determine a relative angular position between the position reference element and the setting reference members by detecting the passage of the position reference element and of the setting reference members during the rotation of the fan,
characterized in that the turbomachine is configured to detect an axial displacement of the fan by detecting an axial displacement of the setting reference members based on said at least one sensor.

The use of at least certain components (setting reference members (targets or claws and sensor(s)) of the system for determining an angular setting position of a turbomachine blade makes it possible to simply detect an axial displacement of several setting reference members, and therefore an axial displacement of the fan, since the members are secured to the disc which is axially displaced with the fan. The use of these existing components, even if they can be somewhat modified structurally according to the situation, makes it possible to avoid having to add dedicated components (particularly one or more sensors), which simplifies the configuration of the turbomachine, its set-up and its maintenance and does not increase the onboard weight or the bulk. Moreover, by using one or more existing sensors the electronics are simplified since a functionality is added without increasing the number of inputs and outputs of the electronic control unit or processing unit.

According to other possible features, taken alone or in combination:
the turbomachine comprises a processing unit which is configured to carry out processing on at least one signal produced by said at least one sensor for the purpose of detecting an axial displacement of the setting reference members;
the processing comprises a comparison between said at least one signal produced by said at least one sensor and at least one reference signal representative of a non-offset axial position of the setting reference members and a detection of an axial displacement of the setting reference members in the event of determination of a difference from said at least one reference signal;
the processing comprises an analysis of said at least one signal produced by said at least one sensor and comprising several successive signal portions, and a detection of an axial displacement of the setting reference members in the event of detection, in said at least one signal thus analyzed, of a signal portion having a shorter period or a smaller amplitude than that of the other signal portions of said at least one analyzed signal;
at least one setting reference member has an overall shape that is elongated along the longitudinal axis and extends from a first end to an opposite second end which is closer to said at least one sensor than the first end and which has a reduced width by comparison with the first end;
at least one setting reference member has an overall shape that is elongated along the longitudinal axis and extends from a first end to an opposite second end which is closer to said at least one sensor than the first end and which has a reduced thickness by comparison with the first end;
the setting reference members are distributed along a circumference of the rotor disc;
the setting reference members are distributed, either into a group of setting reference members or into several groups of setting reference members distributed along a circumference of the rotor disc;
at least certain of the groups of setting reference members each include at least two or three successive setting reference members;
the turbomachine is configured to confirm a detection of an axial displacement, either by detecting the axial displacement at least twice, based on one and the same group of setting reference members, or by detecting the axial displacement at least twice, based on at least two different groups of setting reference members;
the turbomachine comprises a system for controlling the operation of the turbomachine which is configured to stop the operation of the turbomachine in the event of detection of an axial displacement of the fan;
said at least one sensor is chosen from among a variable-reluctance sensor, a capacitive sensor, an inductive sensor, and an optical sensor;
said at least one sensor comprises a plurality of sensors;
the turbomachine is also configured to determine a speed of rotation of the fan based on said at least one sensor;
the turbomachine includes a reduction gear box to which the fan is connected;
the turbomachine includes an axial mechanical stop serving as axial retainment for the fan in the event of axial displacement of this latter.

The invention also has the subject of a method for detecting an axial displacement of a turbomachine fan which is able to rotate about a longitudinal axis XX′ and which comprises a rotor disc and a plurality of blades with variable angular setting mounted at the periphery of the disc, the detecting method comprising the use, on the one hand, of several setting reference members secured to the rotor disc and of at least one sensor positioned fixedly with respect to the fan and on the trajectory of the setting reference members during the rotation of the fan, for detecting an axial displacement of the fan based on the detection of an axial displacement of the setting reference members, the setting reference members and said at least one sensor being used for determining an angular setting position of at least one blade.

The method above provides the same advantages as those of the turbomachine briefly described above and they will therefore not be repeated.

### BRIEF DESCRIPTION OF THE DRAWINGS

Other features and advantages of the subject of this summary will become apparent from the following description of embodiments, given by way of non-limiting example, with reference to the appended figures.

FIG. 1 is a schematic general axial section view of an aircraft turbomachine according to an embodiment of the invention;

FIG. 2 is a magnified schematic general axial half-section view of a part of the turbomachine shown in FIG. 1 in one possible configuration;

FIG. 3 is a schematic general perspective view showing the layout of different components with respect to the fan blades;

FIG. 4 is a schematic partial top view of a part of the components illustrated on FIG. 3;

FIG. 5 is a schematic partial perspective view of the components illustrated on FIG. 4;

FIG. 6 is a schematic view showing an example showing an example of a succession of signals detected by a sensor such as those shown on FIGS. 3 to 5;

FIG. 7 is a schematic view showing a signal detected by a sensor at the input of a threshold comparator;

FIG. 8 is a schematic view showing the signal of FIG. 7 at the comparator output;

FIG. 9 is a schematic view showing different functional components of the information processing line of the sensors;

FIG. 10 is a schematic perspective view of a group formed of three angular setting reference members according to an exemplary embodiment;

FIG. 11 is a schematic view similar to that of FIG. 4 after an axial displacement of the fan;

FIG. 12 is a schematic view showing both a signal detected by a sensor at the input of a threshold comparator and the signal at the output of this comparator with a difference between the periods of the successive signal portions;

FIG. 13A is a schematic view in lateral elevation of an angular setting reference member according to another exemplary embodiment;

FIG. 13B is a schematic perspective view of a group formed of three angular setting reference members according to an exemplary embodiment;

FIG. 14 is a schematic view of a signal detected by a sensor showing a difference in amplitude between the successive signal portions.

### DETAILED DESCRIPTION

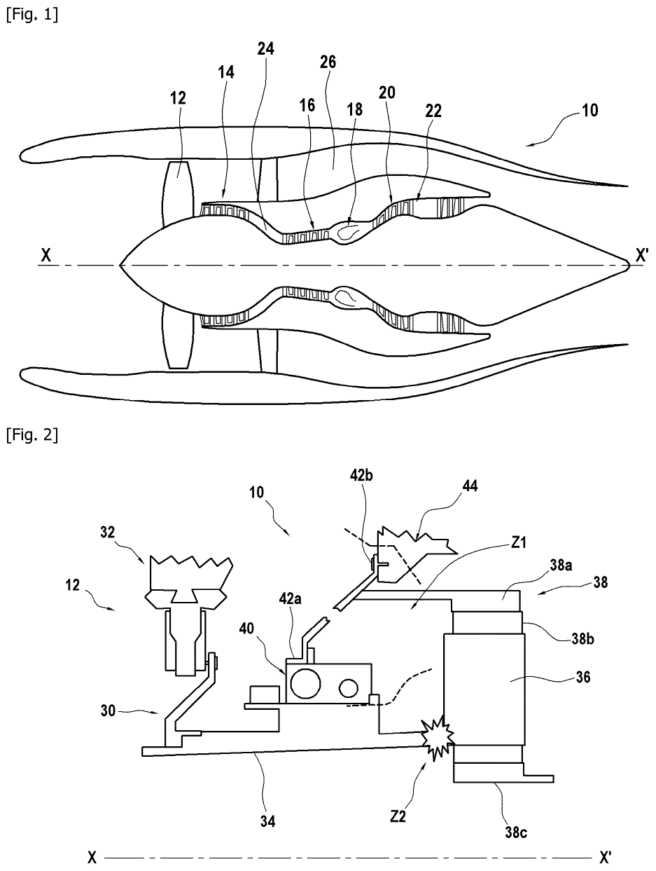

FIG. 1 schematically illustrates, along a longitudinal section, an aircraft turbomachine 10 such as a bypass turbojet engine according to an embodiment of the invention. Other types of turbomachine can be alternatively be envisioned.

The turbomachine 10 here includes, from upstream to downstream along the circulation of the air stream, a ducted fan 12, a low-pressure compressor 14, a high-pressure compressor 16, a combustion chamber 18, a high-pressure turbine 20 and a low-pressure turbine 22. All these elements exert their action in a known manner on a first annular air stream circulating in a first central duct 24 coaxial with the axis XX′. A second bypass annular duct 26 concentrically surrounds the first central duct for the flow of a second annular air stream. Other turbojet engine configurations can alternatively be envisioned with a single compressor and a single turbine, or else with more than two compressors and more than two turbines, or even with an unducted propeller.

The fan 12 which is able to rotate about a longitudinal axis XX′ comprises a rotor disc 30 and a plurality of blades 32 with variable angular settings which are each mounted in a known manner at an outer periphery of the disc, along a circumference thereof. Each blade 32 extends away from the outer periphery of the disc 30 along a radial direction in relation to the longitudinal axis XX′. Each blade 32 also extends along the axial direction and has a suitable aerodynamic profile.

The rotor disc 30 is here connected to the low-pressure shaft of the turbomachine, either directly, or by way of a reduction gear box. The disc forms a part of a central structure of the engine of the turbomachine 10.

FIG. 2 also schematically illustrates (along an axial half-section), in a magnified and partial form of the turbomachine of FIG. 1, the main elements that can be involved in the mechanical assembly connecting the fan 12 to a reduction gear box of the turbojet engine in an exemplary embodiment (note that this is only one possible set-up configuration of the fan and that others may of course be envisioned). The disc 30 of the fan 12 can thus be mounted on a shaft 34 extending downstream in the form of an engagement part 36 which is mechanically meshed with the reduction gear box 38. The reduction gear box 38 may include, in this exemplary embodiment, a planetary carrier 38a inside which planetaries are disposed, one 38b of which is shown, and a sun gear 38c. The sun gear 38c, meanwhile, is connected to the shaft of the downstream low-pressure compressor 14 not shown here.

A support part 40 is mounted concentrically on the outer surface of the shaft 34 (on a part of the shaft with a widened diameter), between the upstream part of the shaft connected to the disc 30 and the downstream engagement part 36. A shroud 42 is mounted via an inner periphery 42a on the support part 40 and via an outer periphery 42b on an axial stop 44, only a part of which is shown here. The axial stop 44 serves as a stop in the event of undesirable axial displacement of the fan. On FIG. 2 the areas Z1 and Z2 represent the areas of fragility where the mechanical couplings are liable to fail in the event of undesirable axial displacement of the fan. Such is the case at the bearing of the axial stop 44 and also at the coupling between the shaft 34 and the downstream engagement part 36 (area Z2) since the box 38 is not designed to take up axial forces. A failure can alternatively take place downstream, inside the box 38.

A known mechanism for changing the angular position of the blades (not shown) is incorporated into the turbomachine in order to orient each blade, around its radial extension direction, according to the angular setting requirements for the operation of the fan. The mechanism generally acts on the supports of the blade roots and orients them suitably, from the inside of the rotor disc.

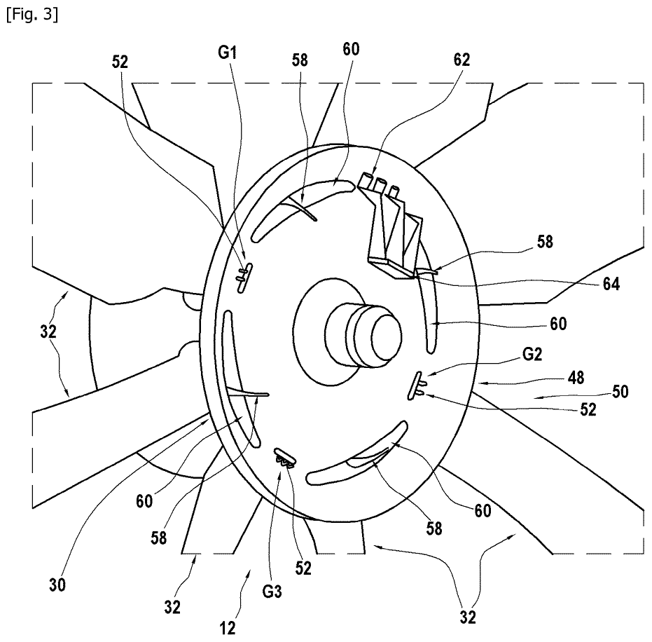

FIG. 3 is a schematic partial perspective view of the fan 12 equipped with the blades 32 partially shown and in front of which is mounted a part 48 rotationally secured to the rotor disc 30 of the fan. The part 48 here takes the form of a shroud or of a disc, the outer peripheral edge is folded in such a way as to form an edge which substantially has the shape of a revolution cylinder around the longitudinal axis XX′. The part 48 could however take other alternative forms not shown here. A system 50 for determining an angular setting position of the blades is mounted in relation to the fan 12 and comprises several components incorporated into the turbomachine, at least some of which are used to detect an axial displacement (change of axial position) of the fan.

This system 50 comprises, generally, several setting reference members (targets or claws) 52 which are secured to the rotor disc 30, by way of the shroud 48, and which therefore turn with this latter during the rotation of the fan. In this example, the setting reference members 52 are for example grouped in the form of several groups or sets of several members 52 each (at least two groups or sets) which are distributed along a circumference of the shroud. By way of example, there are two groups G1, G2 with two members 52 each, disposed in a diametrically opposed manner on the shroud, and one group G3 of three members 52 disposed at an angular orientation of 90° with respect to each of the two groups G1, G2. Although the system here includes more than two members 52, it will be noted that just two members 52 suffice, from a functional point of view, to determine an axial displacement of the fan.

In this example, in each group the setting reference members 52 are laterally separated from one another along a direction which corresponds to a circumferential direction of the shroud and they meet at a shared base, thus forming a kind of rake or fork. Other ways of constituting a group of members 52 can alternatively be used.

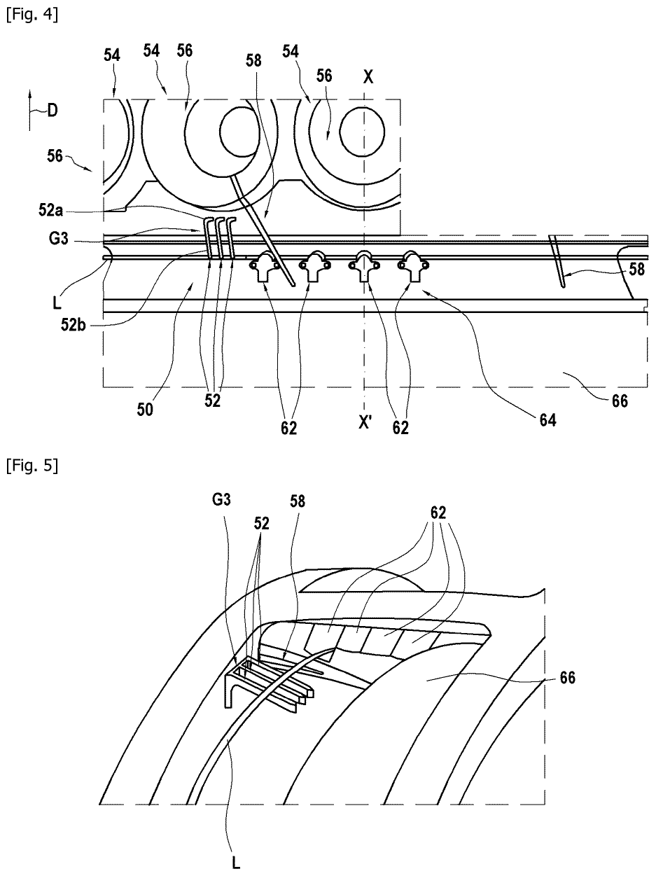

FIG. 4 illustrates a top view of the layout of the group G3 (without the shroud 48) and, above, the layout of several sockets 54 for mounting the blades (the blades are not shown here) located at the outer periphery of the rotor disc 30. In each socket 54 a blade support 56 can be seen, intended to receive the root of the corresponding blade. In this example each member 52 has an overall shape that is elongated along the longitudinal axis and extends, tapering, from a first end 52a located at the base of the group to an opposite second free end 52b located away from the base.

This system 50 also comprises, in general, a position reference element 58, known as a needle, secured to a blade and which is positioned as it would be in the presence of the blade. The needle 58 has an elongated overall shape which extends, from a widened base fixed, for example, to the blade support, away from the blade (alternatively, the needle can be attached to the blade). As shown on FIG. 4, this needle 58 is not aligned along the axis XX′ but forms therewith an angular separation which expresses the fact that the angular orientation (setting) of the blade is liable to vary during the operation of the fan. Thus, the needle 58 is able to change angular position with respect to the setting reference members 52 in the event of a controlled modification of the angular setting of the blade by the mechanism briefly described above. The angular orientation of the needle which can be seen in FIG. 3 is thus able to vary over time and can either move closer to or away from the setting reference members 52. Note that from a functional point of view a needle is not necessary to determine an axial displacement of the fan as described in this document.

Returning to FIG. 3, several through openings 60 are formed in the thickness of the shroud and circumferentially distributed over the latter in order to allow the needles 58 mounted on the blades to extend through these openings. The angular span of each opening 60 is dimensioned to make it possible to cover the entire range of angular deviation of the needle in question. As can be seen on FIG. 3, only certain blades 32 are equipped with a needle. In the example under consideration, only four blades are concerned and the shroud 48 therefore includes four openings 60.

This system 50 also comprises, in general, at least one sensor 62 which is positioned fixedly with respect to the fan. Here said at least one sensor 62 is attached on one stator-forming part of the turbomachine. In the illustrated example several sensors 62 are used, for example four in number.

On FIG. 3 the sensors 62 are mounted on a sensor support 64 which, on FIG. 4, is mechanically secured to the stator part 66 partially shown. Other mountings of the sensor or sensors can alternatively be envisioned.

FIG. 5 is a magnifier partial rear perspective view of the arrangement of FIG. 4 and which shows the relative arrangement of the sensors 62, of the needle 58 and of the setting reference members 52.

In general, the sensor or sensors 62 are able to determine the relative angular position between the needle 58 and the setting reference members 52 by detecting the passage of the needle and of the setting reference members during the rotation of the fan. The use of two setting reference members 52 makes it possible to distinguish between such a member and a needle vis-à-vis a sensor 62. Each sensor 62 provides a signal which is appropriately processed and known by an electronic processing unit.

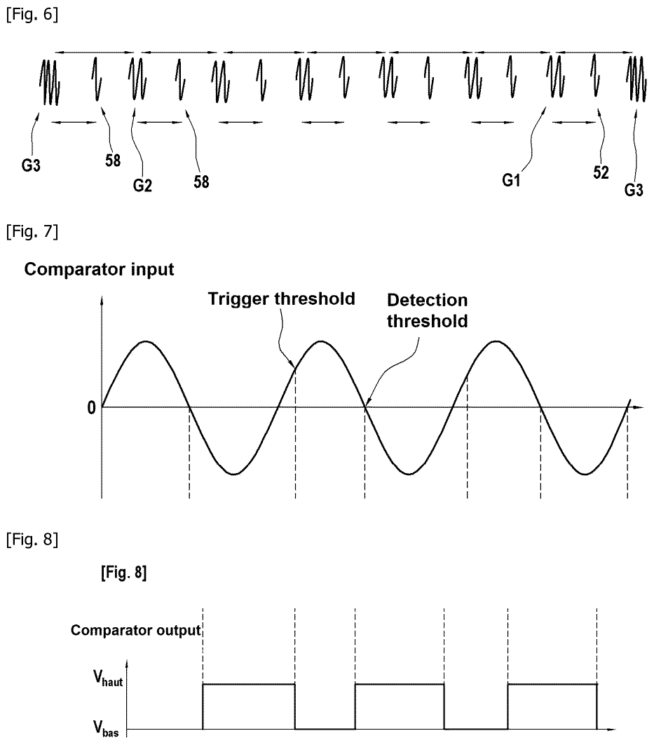

FIG. 6 schematically represents a succession of signals produced by the detection, by a sensor, of the passage of the different groups of setting reference members 52 and of the needles 58. Thus, for the group G3 of three members 52 the signal belongs to a sine wave with three periods, while for the groups G1 and G2 of two members 52, the signal is akin to a pseudo-sine wave with two periods and for the needles the signal is akin to a pseudo-sine wave with a single period.

The electronic processing unit can carry out shaping operations (filtering, comparison with a threshold . . . ) beforehand.

FIG. 7 illustrates a sine wave signal with three periods which is injected at the input of a threshold comparator and FIG. 8 illustrates the signal at the comparator output.

It is thus that is determined an angular setting position of the blades and also that the rotation speed of the fan can be determined (on the rising edges of the digital signals: measurement of the frequency of the signals generated by the sensors, sampling and conversion law . . . ).

By way of example, the sensor or sensors 62 are chosen from among a variable-reluctance sensor, a capacitive sensor, an optical sensor . . . in the embodiments which are described here, the sensor or each sensor is for example a variable-reluctance sensor.

In the event of axial displacement of the fan toward the front of the turbomachine (along the arrow D of FIG. 4), the signal produced by the sensor 62 (if there is only one) or by each of the sensors 62 is modified with respect to a signal produced when the fan has not changed axial position. Such a signal can be described as a reference signal which is representative of a non-offset axial position.

According to a first embodiment, the axial offset of the fan is such that the setting reference members 52 are axially recessed by a distance such that they no longer pass under the sensor or sensors during the rotation of the fan and this latter or these latters thus no longer detect the passage of the members. This situation thus results in a loss of signal (loss of the angular setting information). For this purpose, the members 52 have a calibrated length, i.e. a length which is dimensioned to detect an axial displacement of a predetermined amplitude.

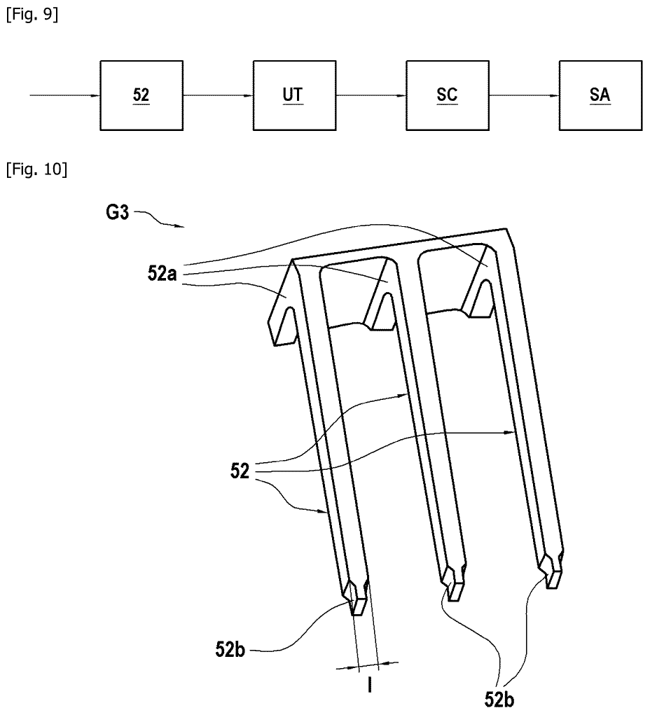

The turbomachine 10 comprises, as schematically represented in FIG. 9, in addition to the electronic processing unit UT, a control system SC of the operation of the turbomachine which is configured to stop the operation of the turbomachine, for example by cutting the fuel supply, in the event of a detection of an axial displacement of the fan.

In this example, when the signal is thus lost by the sensor or sensors 62, the information relating to a loss of information from this or these sensors 62 is transmitted by the electronic processing unit UT to the control system SC controlling the operation of the turbomachine which stops the supply of fuel to the engine. For example, the system SC sends a command to the fuel supply system SA or, more specifically, to a supply valve in order to close it.

Note that before deciding to stop the operation of the turbomachine it is preferable to confirm the detection of the axial displacement of the fan. This can be done by making several detections which all produce the same result. By way of example, this confirmation can take place by detecting the signal loss at least twice in a row during the passage of the same members 52 of one and the same group or else by detecting a signal loss during the passage of several members belonging to different groups which are not necessarily successive. In practice, the detection of signal loss (which leads to the action of shutting off the engine) manifests as the noticing of an absence of signal for a given time period.

According to a second embodiment, the axial offset of the fan can be of a smaller amplitude than that of the first mode, for example in the situation where the axial stop is close to the fan. In such a situation, despite being in recess, the setting reference members 52 remain detectable by the sensor or sensors during the rotation of the fan.

As shown on FIG. 10, at least one of the members 52 can have a free end 52b (end located close to the sensor or sensors) which is tapered or thinned by comparison with the opposite end 52a connected to the base of the group G3 in this example. The thinning is done along the length l of the member or members 52 and is applicable on this figure to all the members of the group. Note that this description is also applicable to a group composed of two members 52.

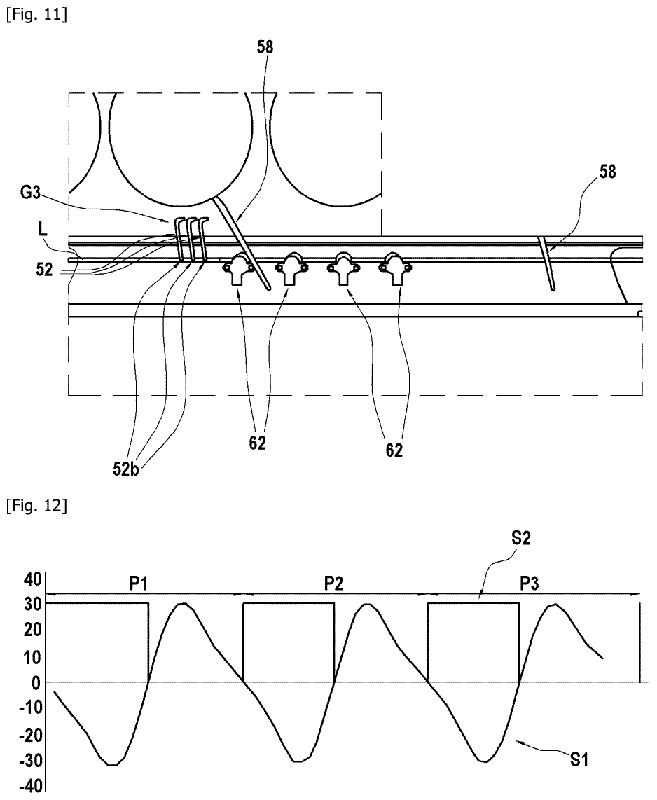

FIG. 11 illustrates an offset axial position of the fan with respect to the position of FIG. 4. The horizontal line referenced L represents the axial position which can be detected by the sensor or sensors 62 and it can be seen that on the FIG. 11 the tapered ends 52b of the members 52 are superimposed on this line.

As mentioned above, the signal produced by a sensor 62, or by each sensor 62 when there are several of them, comprises a succession of two signal portions which can be akin to sine waves or pseudo-sine waves.

In the second embodiment, the detection of an axial displacement of the fan can be done based on a group of three members 52 of which only the middle member 52 has its free end 52b tapered (unlike FIG. 10). This arrangement makes it possible to be able to detect in the signal coming from the sensor or sensors a difference between the signal portion corresponding to the middle member 52 of the group and the two signal portions surrounding the two end members 52, the free end of which is not tapered. Note that the detection can be done using several groups of setting reference members.

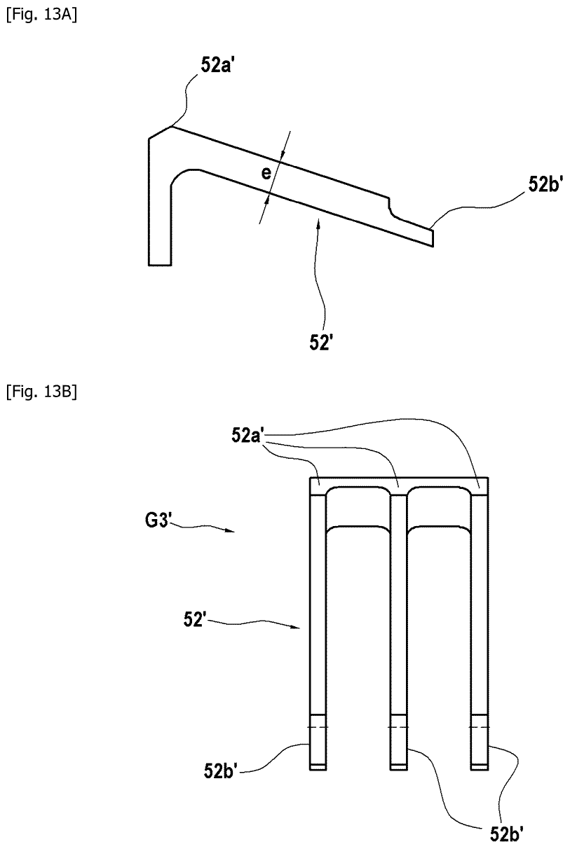

FIG. 12 shows the appearance of the signal produced by a sensor which sees the passage of the group of members 52 of which only the middle member has its end tapered, the two end members each retaining a nominal width at their free end. This figure shows both the signal S1 at the input of the comparator and the signal S2 in the form of slots at the output of the comparator. The signal processing carried out by the processing unit UT on the signal S2 of FIG. 12 makes it possible to identify, from among the successive periods P1, P2 and P3 of the three successive signal portions, the period P2 which is the shortest, this being due to the smaller width of the free end of the middle member 52. The detection of the period P2 in the signal coming from the sensor, or from each sensor if there are several, makes it possible to detect an axial displacement of the fan.

As for the first embodiment, before stopping the operation of the turbomachine, this axial displacement information is confirmed by performing a similar detection with other groups of members 52. Alternatively, the information can be confirmed over several successive detections (for example two or three) or over one complete rotation of the disc.

If the detection of an axial displacement of the fan is done based on the signal or signals produced by the detecting of the passage of a group of two members 52, a single one of the two members can have a tapered end. Thus, the analysis of the resulting signal will result in the determination of two different successive periods for the group, which will make it possible to conclude that an axial displacement of the fan has occurred.

Alternatively, as already mentioned, the axial displacement detection can be done with all the setting reference members 52 of one and the same group (or of several groups each of two, three or more members 52) having a tapered free end. During the processing of the signal produced by detection of the passage of such a group, the unit UT goes on to compare this signal with a reference signal stored in the memory of the unit or of a memory associated with the unit. The reference signal has been previously obtained based on a group of members (or several groups) all having the same nominal width from one end to the other.

Note that to measure the speed of the fan the signal is then processed as illustrated in FIG. 12, arming the trigger when the signal crosses a certain positive threshold, taking a reference time when the signal 10 changes to zero Volts with an armed trigger and computing the signal period as the duration between two takings of reference times.

A third embodiment will now be described. According to this mode at least one setting reference member 52′ is structurally modified so that the signal produced on detection of the passage of the member in front of the sensor or sensors is representative of this modification.

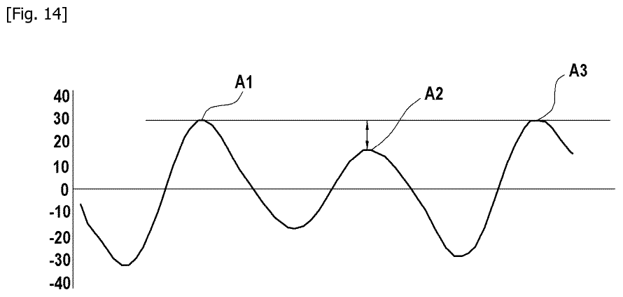

As shown on FIG. 13A, the member 52′ has a free end 52b′ (that located as near as possible to the sensor or sensors) the thickness of which is reduced by comparison with the nominal thickness e of the member. FIG. 13B shows a group G3′ of three members 52′ which all have a free end 52b′ of reduced thickness. Note that the transverse or lateral separation between two consecutive members or claws 52′ is determined as a function of the angular setting range, particularly in order to avoid confusing the detection of a group of three members with a group of two members followed by a needle. This remark is also applicable to the other embodiments described previously.

In this third embodiment, the detection of an axial displacement of the fan can be done based on a group of three members 52′ of which only the middle member 52′ has its free end 52b′ of reduced thickness (unlike FIG. 13B). This arrangement makes it possible to be able to detect, in the signal coming from the sensor or sensors, a difference between the signal portion corresponding to the middle member 52′ of the group and the two signal portions corresponding to the two end members 52′ (which each have a free end with a constant nominal thickness) surrounding the middle member 52′.

FIG. 14 shows the appearance of the signal produced by a sensor which sees the passage of the group of members 52′ of which only the middle member has its end of a reduced thickness, the two end members each keeping at their free end a nominal thickness e. This figure shows the output signal of a sensor. The signal processing carried out by the processing unit UT on the signal of FIG. 14 makes it possible to identify, from among the three successive signal portions constituting the signal, the portion of smallest amplitude (in this case the second signal portion surrounded by the two signal portions corresponding to the two end members 52′ of nominal thickness). This is due to the reduced thickness of the free end of the middle member 52′ which causes an increase in the air gap between the member 52′ and the or each sensor. The detection of the smaller amplitude A2 by comparison with the two amplitudes A1 and A3 in the signal coming from the sensor, or of each sensor if there are several of them, makes it possible to detect an axial displacement of the fan.

As for the two first embodiments, before stopping the operation of the turbomachine, this information is confirmed, for example by performing a similar detection with other groups of members 52′. Alternatively, the information can be confirmed over several successive detections (for example two or three) or over one complete rotation of the disc.

As for the second embodiment, in the situation where the detection of an axial displacement of the fan is done based on the signal or signals produced by detection of the passage of a group of two members 52′, a single one of the two members can have a tapered end. Thus, the analysis of the resulting signal will result in the determination of two different successive amplitudes for the group, which will make it possible to conclude that an axial displacement of the fan has occurred.

Alternatively, as already mentioned, the detection of an axial displacement can be done with all the setting reference members 52′ of one and the same groups (or of several groups each of two, three or more members 52′) having a free end of reduced thickness. During the processing of the signal produced by the detection of the passage of such a group, the unit UT goes on to compare this signal with a reference signal stored in the memory of the unit or of a memory associated with the unit. The reference signal has been obtained previously based on a group of members all having the same nominal thickness from one end to the other.

The electronic processing unit or electronic control unit UT of the turbomachine is configured to implement a method for detecting an axial displacement of the fan according to one or more embodiments of the invention. Such a method particularly comprises steps of detecting a signal by one or more sensors during the passage of several angular setting reference members (optionally combined into one or more groups), then of processing this signal, optionally by comparison with at least one reference signal representative of a non-offset axial position of the fan, in order to detect an axial displacement of several angular setting reference members.

This invention is just as applicable to a turbomachine equipped with a reduction gear box as to a turbomachine that does not have one.

Although this description refers to specific exemplary embodiments, modifications can be made to these examples without departing from the general scope of the invention as defined by the claims. Moreover, individual features of the different embodiments illustrated or mentioned can be combined into additional embodiments. Consequently, the description and drawings must be considered in an illustrative sense rather than a restrictive one.

1. An aircraft turbomachine comprising:
a fan which is able to rotate about a longitudinal axis and which comprises a rotor disc and a plurality of blades with variable angular setting mounted at the periphery of the disc,
a system for determining an angular setting position of at least one blade comprising:
several setting reference members which are secured to the rotor disc,
a position reference element secured to said at least one blade and which is able to change angular position with respect to the setting reference members in the event of modification of the angular setting of said at least one blade,
at least one sensor which is positioned fixedly with respect to the fan and which is able to determine a relative angular position between the position reference element and the setting reference members by detecting the passage of the position reference element and of the setting reference members during the rotation of the fan,
wherein the turbomachine is configured to detect an axial displacement of the fan by detecting an axial displacement of the setting reference members based on said at least one sensor.

2. The turbomachine as claimed in claim 1, wherein the turbomachine comprises a processing unit which is configured to carry out processing on at least one signal produced by said at least one sensor for the purpose of detecting an axial displacement of the setting reference members.

3. The turbomachine as claimed in claim 2, wherein the processing comprises a comparison between said at least one signal produced by said at least one sensor and at least one reference signal representative of a non-offset axial position of the setting reference members and a detection of an axial displacement of the setting reference members in the event of determination of a difference from said at least one reference signal.

4. The turbomachine as claimed in claim 2, wherein the processing comprises an analysis of said at least one signal produced by said at least one sensor and comprising several successive signal portions, and a detection of an axial displacement of the setting reference members in the event of detection, in said at least one signal thus analyzed, of a signal portion having a shorter period or a smaller amplitude than that of the other signal portions of said at least one analyzed signal.

5. The turbomachine as claimed in claim 1, wherein at least one setting reference member has an overall shape that is elongated along the longitudinal axis and extends from a first end to an opposite second end which is closer to said at least one sensor than the first end and which has a reduced width by comparison with the first end.

6. The turbomachine as claimed in claim 1, wherein at least one setting reference member has an overall shape that is elongated along the longitudinal axis and extends from a first end to an opposite second end which is closer to said at least one sensor than the first end and which has a reduced thickness by comparison with the first end.

7. The turbomachine as claimed in claim 1, wherein the setting reference members are distributed along a circumference of the rotor disc.

8. The turbomachine as claimed in claim 7, wherein the setting reference members are distributed, either into a group of setting reference members or into several groups of setting reference members distributed along a circumference of the rotor disc.

9. The turbomachine as claimed in claim 8, wherein at least certain groups of the setting reference members each include at least two or three successive setting reference members.

10. The turbomachine as claimed in claim 8, wherein the turbomachine is configured to confirm a detection of an axial displacement, either by detecting the axial displacement at least twice, based on one and the same group of setting reference members, or by detecting the axial displacement at least twice, based on at least two different groups of setting reference members.

11-15. (canceled)

16. The turbomachine as claimed in claim 9, wherein the turbomachine is configured to confirm a detection of an axial displacement, either by detecting the axial displacement at least twice, based on one and the same group of setting reference members, or by detecting the axial displacement at least twice, based on at least two different groups of setting reference members.

17. The turbomachine as claimed in claim 1, further comprising a system for controlling the operation of the turbomachine which is configured to stop the operation of the turbomachine in the event of detection of an axial displacement of the fan.

18. The turbomachine as claimed in claim 1, wherein said at least one sensor is chosen from among a variable-reluctance sensor, a capacitive sensor, an inductive sensor, and an optical sensor.

19. The turbomachine as claimed in claim 1, wherein the turbomachine is also configured to determine a speed of rotation of the fan based on said at least one sensor.

20. The turbomachine as claimed in claim 1, further including a reduction gear box to which the fan is connected.

21. A method for detecting an axial displacement of a turbomachine fan which is able to rotate about a longitudinal axis and which comprises a rotor disc and a plurality of blades with variable angular setting mounted at the periphery of the disc,
the detecting method comprising the use, on the one hand, of several setting reference members secured to the rotor disc and of at least one sensor positioned fixedly with respect to the fan and on the trajectory of the setting reference members during the rotation of the fan, for detecting an axial displacement of the fan based on the detection of an axial displacement of the setting reference members, the setting reference members and said at least one sensor being used for determining an angular setting position of at least one blade.
